(19) United States
(12) Patent Application Publication
(10) Pub. No.: US 2008/0287558 A1
(43) Pub. Date: Nov. 20, 2008

(54) Method of the Preparation of Vulcanization Mixtures by the De-Vulcanization of Waste Rubber

(76) Inventors: Vladimir Kubanek, Praha (CZ); Miroslav Durdak, Luhacovice (CZ); Vladimir Caska, Praha (CZ); Pavel Smetana, Praha (CZ)

Correspondence Address: NOTARO AND MICHALOS, 100 DUTCH HILL ROAD, SUITE 110, ORANGEBURG, NY, 10962-2100, US

(21) Appl. No.: 12/095,219

(22) PCT Filed: Nov. 30, 2006
(86) PCT No.: PCT/CZ2006/000085

§ 371 Date: Jul. 29, 2008

(30) Foreign Application Priority Data
Dec. 2, 2005 (CZ) PV2005-752

(51) Int. Cl. C08J 11/28

(52) U.S. Cl. 521/42

(57) ABSTRACT

Waste rubber in the from of crumbs, mainly from automobile tires, but also from other used rubber products including waste rubber formed in the course of their manufacturing, is mixed in a kneader, calender, or extruder with a compound containing the chemical group —SO₂—NH—. Subsequently, at temperatures up to 180° C. the rubber crumbs are de-vulcanized within 15-20 minutes, the de-vulcanization degree being controlled by the de-vulcanization agent concentration, and time and temperature of de-vulcanization. After the eventual addition of small amounts of extenders as oil, soot, raw rubber, inorganic filler and the vulcanization agent a vulcanization mixture is obtained that after pressing into the shape of the rubber product is subjected to a standard vulcanization process.

### TECHNICAL FIELD

The invention relates to a method of the preparation of vulcanization mixtures by the waste rubber de-vulcanization using compounds containing the chemical group —SO₂—NH—.

### BACKGROUND ART

The worldwide increase of the amounts of waste rubber, particularly in the form of used tires (about 65-70 percent), but also of other used rubber products, including rubber waste formed during the production of all rubber products, poses an enormous economic, ecological and thus also a social problem. For this reason a great pressure is exerted on the research institutions as well as on the rubber products producers to solve this problem in order to exploit waste rubber rather as a valuable secondary raw material then to dispose of it by dumping in waste dumps, by burning or gasification.

A number of rubber products producers try to solve this problem at least partially using waste rubber secondary in the form of a granulate as an extender into the vulcanization mixture without any other pretreatment or using heat pretreatment with hot oil so that it becomes softer. In both cases it is used for manufacturing technically less demanding products. However, such utilization of waste rubber concerns only a limited amount of the material.

Very promising seemed the use of large amounts of crushed waste rubber as filler into the bituminous and asphalt mixtures for roads. However, the practice revealed that only limited amounts of this material can be used due to the inhomogeneity of the mixture caused by the incomplete de-vulcanization of rubber, and thus the stickiness and pilling of the mixtures were not achieved. This situation resulted in their cracking at lower temperatures and formation of ruts on the roads. When higher concentrations of waste rubber were used in the bituminous and asphalt mixtures there were observed problems with the driving of motor vehicles in curves.

A substantial part of tires is so far burned in the cement works furnaces which is undesirable both from the ecological and economical points of view, notwithstanding the fact that the waste rubber is thus irrevocably lost as a secondary raw material. In the Czech Republic the Ministry of Environment Protection issued a temporary exception allowing burning of rubber waste in cement furnaces up to 2008. Thereafter it will be strictly prohibited.

Dumping of used tires or of other used rubber products in the dumping sites of municipal waste are out of the question. Dumping of these products on the sea bottom is also prohibited.

Experiments with gasification or destruction of waste rubber by ozonation did not come out useful both from the economic and also technical reasons. Also in these cases waste rubber is irrevocably lost as a secondary raw material.

A number of technical proposals and patents for the solution of this problem, i.e., of the economic use of waste rubber, appeared in the published literature but nearly any of them had not been so far used on a large scale project.

The most ideal solution would be to find a simple process of the waste rubber de-vulcanization, from which a vulcanization mixture for the production of new rubber products could be prepared. However, in this case the situation is complicated by the fact that a number of different prescriptions exist for the preparation of rubber products so that the waste rubber is a raw material of variable composition and this rubber must be therefore collected and processed separately. Only in some cases the different composition and different origin of the de-vulcanized rubber is of no consequence as, for instance, in the manufacturing of cables or fillers into road mixtures.

Most of the scientific publications in the technical literature on rubber deal with the theoretical explanation of the formation and description of crosslinks in various rubbers. All these studies state that the rubber vulcanization is a predominantly chemical process that is, however, accompanied by physical colloidal and absorption processes. However, in the technical literature there is not a single study dealing theoretically with the possibility of a simple method of rubber de-vulcanization, i.e., of a reverse process to vulcanization as it had been commonly assumed that the rubber crosslinking is basically an irreversible process. In spite of this opinion the process of waste rubber de-vulcanization according to the Czech patent No. 286214 appeared to be very promising. According to this patent de-vulcanized sticky rubber is formed, containing already all extenders so that a raw material is obtained that—after the addition of a curing agent can be processed by a classical procedure to new rubber products.

Based on the studies of technical literature and exploiting the experience gained in the studies of the waste rubber de-vulcanization according to the Czech patent No. 286214 from the year 2000, new technological ways of a still simpler ecological and more economical method of the waste rubber de-vulcanization have been looked for in order to prepare vulcanization mixtures containing up to 90 percent of waste rubber, depending on the content of additives as extenders.

It has been found that for the solution of the problems with the preparation of vulcanization mixtures connected with the de-vulcanization of waste rubber there can be used compounds having in their molecules a group or more groups capable to disintegrate the intermolecular crosslinks of the rubber.

### DISCLOSURE OF INVENTION

An object of the present invention is the use of compounds of the general formula I

M-(O—[CO—(CH₂)ₓ—NH]_{y}—SO₂—NH₂)_{z} (I)

where M is a hydrogen atom or an atom of a metal from the group comprising Ca, Mg, Na and K,
x is an even integer from 6 to 12,
y is 0 or 1, and
z is 1 or 2,
for the de-vulcanization of rubber or for the vulcanization of rubber.

The de-vulcanization with the use of the compounds of the general formula I proceeds very rapidly (within few minutes) at low temperatures preferably up to 80° C. and there are no exhalations released into the atmosphere.

At higher temperatures exceeding 100° C. the compounds of the general formula I act as vulcanization agents or as the vulcanization accelerators.

The process of waste rubber reprocessing for vulcanization_according to the present invention is very simple and undemanding on energy.

The object of the present invention is a method of rubber de-vulcanization of waste rubber materials wherein the waste rubber in the form of crumbs or dust is under normal temperature homogenized with a compound of the general formula I and possibly also with the additives commonly used in rubber-making industry and the mixture is thereafter de-vulcanized at temperatures ranging from 40 to 100° C. for a time period of 10 to 60 minutes.

Subsequently, the rubber crumbs are de-vulcanized and the de-vulcanization degree can be controlled by the concentration of the de-vulcanization agent and by the time and temperature of de-vulcanization.

It is an aspect of the present invention that the de-vulcanization compound of the general formula I is used in a concentration of 0.1 to 5 wt. % related to the amount of waste rubber used.

It is a further aspect of the present invention that the de-vulcanization is performed in a time period of 15 to 30 minutes.

Preferably the de-vulcanization proceeds at temperatures of up to 80° C. for a time period of 15 to 20 minutes. The mixing can be carried out in a kneader as well as an extruder or a calender.

A further object of the present invention is a method of rubber vulcanization wherein a compound of the general formula I is used at temperatures above 100° C. as vulcanization agent or vulcanization accelerator in combination with commonly used vulcanization agents.

After eventual addition of small amounts of extenders such as oil, soot, raw rubber, inorganic extender, and vulcanization agent, a vulcanization mixture is obtained that is subsequently processed in an extruder or on a calender or in a combination of both these devices to form sheets that are used as raw material for the direct processing by the classical vulcanization process to obtain rubber products.

The invention is illustrated by examples which should not be construed as further limiting.

### EXAMPLES

### Example 1

50 parts by weight of waste butadiene-styrene rubber crumbs with particles of the size up to 4 mm were homogenized in a calender with 2.0 wt. % of calcium amidosulfonate as a regeneration agent. Then, 5 wt. % of raw butadiene rubber were added. By the action of shear friction the temperature of the mixture increased to about 70-80° C. At this temperature the regeneration de-vulcanization compound started to react with the rubber. The obtained material was after the addition of 1% of sulfur subjected to vulcanization at 145-165° C. The vulcanized product exhibited comparable properties (strength, elasticity, hardness, and abrasion) with similar products prepared from standard vulcanization mixtures.

### Example 2

100 parts by weight of waste rubber from trucks in the from of powder with powder particles of the size of 0.2-0.4 mm were mixed in a kneader at temperatures of 20-50° C. with 2 wt. % of calcium bis(6-aminohexanoate)amidosulfonate as the regeneration de-vulcanization compound. The resulting mixture was further homogenized together with 5 wt. % of soot for the rubber-making industry and with 2 wt. % of colophony. The temperature of the mixture increased to 70-80° C. Then, 1 wt. % of sulfur were added and the thus obtained vulcanization mixture underwent vulcanization at 130-150° C. In comparison with the original time of vulcanization, the time of vulcanization decreased by 15-20%. The resulting rubber exhibited a very homogeneous structure and in comparison with the common technical rubber of similar composition it was somewhat softer.

### Example 3

150 parts by weight of butadiene-polystyrene rubber of the particle size 0.2-0.5 mm, obtained from discarded conveyer belts were mixed at ambient temperature in a kneader with 15 wt. % of the inorganic powder filler and with 5 wt. % of heavy oils for rubber-making industry. To the thus obtained mixture 3 wt. % of the amidosulfonate of the aminocaproic acid as the regeneration de-vulcanization compound and 2 wt. % of sulfur were added. The further homogenization was carried out in a calender at a temperature of 50-60° C. By vulcanization at the temperature of 145-160° C. a material suitable for the manufacturing of shoe soles or cable jackets was obtained

### Example 4

300 parts by weight of waste ethylene-propylene rubber in the form of crumbs with a particle size of 3 to 4 mm were mixed in a calender with 2.5 wt. % of amidosulfonate of the dodecylbenzene-sulfonic acid as the regeneration de-vulcanization compound. By heating the mixture by shear friction in a calender to a temperature of 60-70° C. and the subsequent vulcanization at 145-155° C. a material suitable for the preparation of sealing materials for roofing and various materials for outdoor use with anticorrosive properties was obtained.

### Example 5

50 parts by weight of waste butadiene-styrene rubber in the from of a granulate with particles of the size up to 3 mm were slowly homogenized at ambient temperature in a kneader with 2.5 wt. % of magnesium bis-(6.aminohexanoate) amidosulfonate as the regeneration de-vulcanization compound. Thereafter, de-vulcanization proceeded within 10 minutes at the temperature of 50-70° C. in an extruder. Then the 100% de-vulcanized waste underwent vulcanization at the temperature of 150-160° C. without the addition of a vulcanizing agent. The thus obtained rubber exhibited properties (strength, elasticity, hardness, abrasion) nearly identical with rubber prepared by the same procedure from raw rubber.

### INDUSTRIAL APPLICABILITY

The waste rubber de-vulcanization method according to the invention is applicable for the preparation of vulcanization mixtures making possible full usage of waste rubber as a secondary raw material for the production of new rubber products.

1. Use of a compound of the general formula I
M-(O—[CO—(CH₂)ₓ—NH]_{y}—SO₂—NH₂)_{z} (1)
where M is a hydrogen atom or atom of a metal from the group comprising Ca, Mg, Na and K,
x is an even integer from 6 to 12,
y is 0 or 1, and
z is 1 or 2,
for the de-vulcanization of rubber or for the vulcanization of rubber.

2. A method of rubber de-vulcanization from waste rubber materials, characterized in that the waste rubber in the form of crumbs or powder is at ambient temperature homogenized with a compound of the general formula (I) according to claim 1 and at the eventual addition of extenders commonly used in the rubber-making industry, subjected to de-vulcanization at temperatures at a range of from 40 to 100° C. during the time period of 10 to 60 minutes.

3. The method according to claim 2, characterized in that the de-vulcanization compound of the general formula (I) is used in a concentration of 0.1 to 5 wt. % related to the amount of the used waste rubber.

4. The method according to claim 2, characterized in that de-vulcanization is performed during a time period of 15 to 30 minutes.

5. A method of rubber vulcanization, characterized in that a compound of the general formula I according to claim 1 is used at temperatures above 100° C. as a vulcanization agent or accelerator of vulcanization in combination with commonly used vulcanization agents.
